(19) United States
(12) Patent Application Publication
(10) Pub. No.: US 2010/0227167 A1
(43) Pub. Date: Sep. 9, 2010

(54) Decorating wire capable of showing a hollow spiral strap

(75) Inventor: Cheng-Lang Tsai, San Chung City (TW)

Correspondence Address: BACON & THOMAS, PLLC, 625 SLATERS LANE, FOURTH FLOOR, ALEXANDRIA, VA, 22314-1176, US

(73) Assignee: Yun-Yu Tsai, San Chung City (TW)

(21) Appl. No.: 12/379,956

(22) Filed: Mar. 5, 2009

(51) Int. Cl. B32B 1/00

(52) U.S. Cl. 428/375

(57) ABSTRACT

A decorating wire capable of showing a hollow spiral strap includes a core wire, a first transparent plastic body, a first strap and a second transparent plastic body. The first transparent plastic body is wrapped around the core wire. The first strap is wound spirally and axially on the first transparent plastic body and maintains a predetermined interval along the first transparent plastic body. The second transparent plastic body is wrapped onto the first transparent plastic body and the first strap. The second transparent plastic body has a thickness from 0.5 mm to 1.5 mm, so that the first strap can provide a light refraction effect due to the thickness of the second transparent plastic body, and show a visual effect of winding the first strap onto the second transparent plastic body. The color and interval of the transparent plastic bodies and straps can be changed for different designs.

### FIELD OF THE INVENTION

The present invention relates to a decorating wire, and more particularly to a decorating wire having a first transparent plastic body wrapped onto a core wire (such as a cotton thread or a fishing line), a strap wound onto the first transparent plastic body, and a second transparent plastic body wound onto the first transparent plastic body and the strap, such that the clarity and a variety of colors of the strap can be shown through each transparent plastic body.

### BACKGROUND OF THE INVENTION

In recent years, our living standard becomes increasingly higher, and we continue improving our life quality, and thus various different products are introduced, updated and improved constantly. Manufacturers spare no effort to develop and improve their products to meet consumer requirements including the convenience, practicability and stylish design and aggressively seize the business opportunity of the related market, and enhance their competitiveness to maximize the profit of their business.

In general, we usually carry a purse or a hand bag for putting necessary objects such as keys, cosmetics, coins and portable electronic products (including mobile phone, PDA, walkman, etc) with us when we go out. Obviously, the quantity of the aforementioned necessary objects is much greater than that in the past, and the purse or hand bag used for carrying these objects becomes a necessary or indispensible tool when we go out. As various new products are introduced to the market, it is a major issue for manufacturers to break through and attract consumers' attention among all these products to gain the best business opportunity.

With reference to FIG. 1 for a conventional hand carry bag, the hand carry bag 2 comprises a bag body 20, a cover 21 and a carry strap 22, wherein a containing space 200 is defined in the bag body 20 and provided for users to put objects, and a portion of the cover 21 proximate to a side is coupled to a top position proximate to a lateral side of the bag body 20, and the cover 21 is covered onto the top side of the bag body 20, so that a portion of the cover 21 proximate to another side can be extended and covered onto another lateral side of the bag body 20, and both ends of the carry strap 22 are disposed on the remaining two sides of the bag body 20 respectively, and the position proximate to the top edge of the bag body 20 is provided for users to grip. The hand carry bag 2 further comprises a plurality of decorating wires 23 disposed on edges of the bag body 20 and the cover 21, and the decorating wires 23 have a flake 230, and the decorating wires 23 are sewed onto a seam between edges of the bag body 20 and the cover 21 by the flake 230, so that each decorating wire 23 can be used for preventing the wires sewed onto the bag body 20 and the cover 21 from being exposed and avoiding a chaotic appearance or a low-quality manufacture of the hand carry bag 2. In the meantime, the hand carry bag 2 can be decorated by the decorating wires 23 to improve the overall beauty of the hand carry bag 2.

However, the aforementioned conventional decorating wire 23 of the hand carry bag 2 still has the following drawbacks in its practical applications:

1. The decorating wire 23 is generally manufactured by an extrusion molding method, and thus it generally comes with a single color only, and its color can be changed by adding a different dye to show a monotonic or irregular change, but such arrangement cannot give a variation of colors with a crystal clear effect. As a result, the decorating wire 23 can hardly enhance the overall beauty of the hand carry bag 2.

2. If a color silk thread is used directly for making the decorating wire 23, the manufacturing process will become more difficult, require more manpower, and incur a higher manufacturing cost. Furthermore, dusts and dirts will remain easily on the surface of the decorating wire 23 made by the silk thread, and it is difficult to wash and clean the surface of such decorating wire 23, and the surface may be worn or abraded easily. As a result, the decorating wire 23 cannot last long.

In summation of the description above, it is an important subject for decorating wire designers or manufacturers to design and develop a novel decorating wire to overcome the shortcomings of the conventional decorating wire and achieve the effects of enhancing the overall beauty and the design variability of the hand carry bag by the decorating wire and extending the life expectancy of the decorating wire effectively.

### SUMMARY OF THE INVENTION

In view of the foregoing shortcomings of the conventional decorating wire, the inventor of the present invention based on years of experience in the related industry to conduct extensive researches and experiments, and finally designed a decorating wire capable of showing a hollow spiral strap in accordance with the present invention to achieve the effects of using the decorating wire to enhance the overall beauty and the design variability of the product, extending the life expectancy of the decorating wire, providing a color variation with a crystal clear effect to the monotonic single-color conventional decorating wire that cannot catch the eyes of consumers effectively, solving the aforementioned problems of the conventional decorating wire, and overcoming the shortcomings of the prior art.

Therefore, it is a primary objective of the present invention to provide a decorating wire capable of showing a hollow spiral strap, and the decorating wire comprises a core wire, a first transparent plastic body, a first strap and a second transparent plastic body, wherein the first transparent plastic body is formed onto and completely wrapped around the core wire (which is a cotton thread or a fishing line, etc) by an extrusion molding method, and the core wire is provided for enhancing the axial strength of the first transparent plastic body, and the first strap is wound spirally onto the first transparent plastic body and along the axial direction of the first transparent plastic body, and keeps a predetermined interval, and the second transparent plastic body is formed onto and completely wrapped around the first transparent plastic body and the first strap by the extrusion molding method, and the second transparent plastic body has a thickness falling within a range from 0.5 mm to 1.5 mm, so that the first strap can provide a light refraction effect due to the thickness of the second transparent plastic body, and show a visual effect of being wound onto the second transparent plastic body. In addition, the decorating wire can show a hollow spiral variation of the first strap with a crystal clear effect and a color change by changing the color of each transparent plastic body or the first strap, or changing the interval of the spiral first straps, so that manufacturers can enhance the overall beauty and the design variability of the manufactured product (such as a cushion, a stationery bag, a cosmetic bag, or any other bag) by the decorating wire. Since the surface of the decorating wire is protected by the second transparent plastic body, therefore the life expectancy of the decorating wire can be extended effectively.

Another objective of the present invention is to extend at least one connecting plate extended outwardly from a surface of the second transparent plastic body, and each connecting plate along an axial direction of the decorating wire, so that the decorating wire can be sewed to a seam of the object through each connecting plate and matched with the original color of the leather or fabric material of the object to enhance the overall beauty of the object.

A further objective of the present invention is to provide a decorating wire capable of showing a hollow spiral strap, and the decorating wire comprises a core wire, a first transparent plastic body, a first strap, a second transparent plastic body, at least one second strap and a third transparent plastic body, wherein the first transparent plastic body is formed onto the core wire by an extrusion molding method and completely wrapped around the core wire, and the core wire is provided for enhancing an axial strength of the first transparent plastic body, and the first strap is wound spirally onto the first transparent plastic body and along an axial direction of the first transparent plastic body and maintains a predetermined interval along the first transparent plastic body, and the second transparent plastic body is formed onto the first transparent plastic body by the extrusion molding method and completely wrapped around the first transparent plastic body and the first strap, and each second strap is wound onto the second transparent plastic body in a same direction or an opposite direction with the first strap and along an axial direction of the second transparent plastic body, and the third transparent plastic body is formed onto the second transparent plastic body by the extrusion molding method and completely wrapped around the second transparent plastic body and each second strap, and the second transparent plastic body and the third transparent plastic body have a thickness falling within a range from 0.5 mm to 1.5 mm. Therefore, each strap provides a light refraction effect due to the thickness of the second transparent plastic body and the third transparent plastic body and visually shows the effect of being wound onto the third transparent plastic body. Since the decorating wire includes different wound straps, therefore a color variation of each transparent plastic body can be achieved by the arrangement of a different hollow spiral strap in a different color and with a different interval.

Another further objective of the present invention is to maintain an axial strength of the core wire greater than each transparent plastic body, so that the core wire can enhance the axial strength of each transparent plastic body effectively and prevent each transparent plastic body from being deformed, cracked or broken during the extrusion molding process, so as to improve the yield rate of the decorating wire effectively.

### BRIEF DESCRIPTION OF THE DRAWINGS

FIG. 1 is a schematic view of a conventional hand carry bag and its decorating wire;

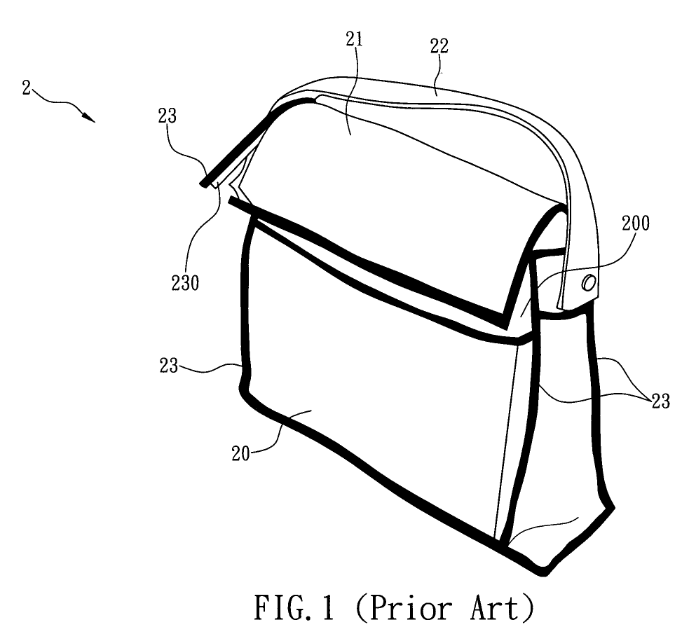

FIG. 2 is a schematic view of a decorating wire capable of showing a hollow spiral strap in accordance with a first preferred embodiment of the present invention;

FIG. 3 is a schematic view of a decorating wire capable of showing a hollow spiral strap in accordance with a second preferred embodiment of the present invention; and

FIG. 4 is a schematic view of a decorating wire capable of showing a hollow spiral strap in accordance with a third preferred embodiment of the present invention.

### DETAILED DESCRIPTION OF THE PREFERRED EMBODIMENTS

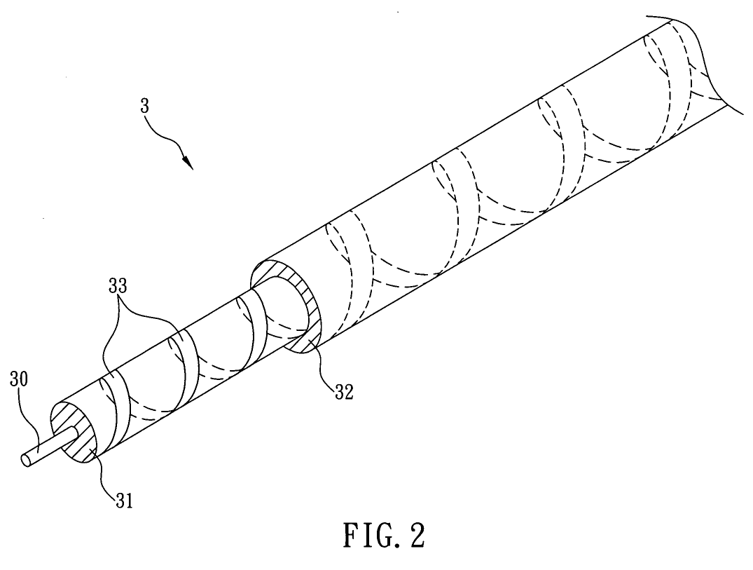

With reference to FIG. 2 for a decorating wire capable of showing a hollow spiral strap in accordance with a first preferred embodiment of the present invention, the decorating wire 3 comprises a core wire 30, a first transparent plastic body 31, a first strap 33 and a second transparent plastic body 32, wherein the first transparent plastic body 31 is formed onto the core wire 30 (which is a cotton thread or a fishing line, etc) by an extrusion molding method and completely wrapped around the core wire 30, and maintains a predetermined cross-sectional area, and the first strap 33 is wound spirally along an axial direction of the first transparent plastic body 31 and maintains a predetermined interval along the first transparent plastic body 31, such that the first strap 33 can show a hollow spiral form due to the property of a transparent material of the first transparent plastic body 31, and the second transparent plastic body 32 is formed onto the first transparent plastic body 31 by the extrusion molding method, and completely wrapped around the first transparent plastic body 31 and the first strap 33, and the second transparent plastic body 32 has a thickness falling within a range from 0.5 mm to 1.5 mm.

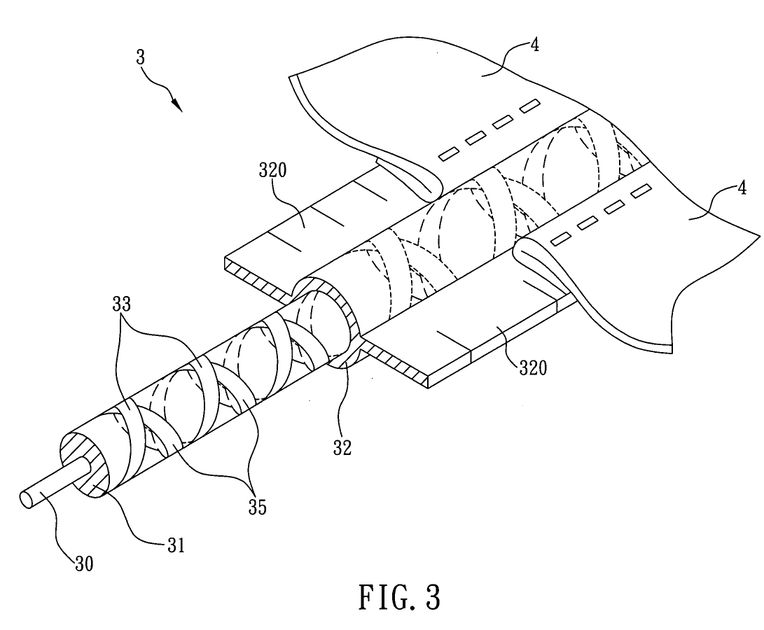

The first strap 33 has a light refraction effect due to the thickness of the second transparent plastic body 32, and shows a visual effect of being wound onto the second transparent plastic body 32. In addition, the decorating wire 3 can show various hollow spiral forms of the first strap 33 by a change of colors of the first transparent plastic body 31, the second transparent plastic body 32 or the first strap 33, or a change of intervals of the spiral first strap 33. In FIG. 3, the decorating wire 3 is woven as a finished good (such as a cushion) or sewed to a seam of an object 4 (such as a stationery bag, a cosmetic bag, or any other bag) to enhance the overall beauty and the design variability of the finished good and the object 4 effectively. Since the surface of the decorating wire 3 is protected by the second transparent plastic body 32, therefore the life expectancy of the decorating wire 3 can be extended effectively.

With reference to FIG. 3 for a decorating wire in accordance with a second preferred embodiment of the present invention, the decorating wire 3 comprises a core wire 30, a first transparent plastic body 31, a first strap 33, a second transparent plastic body 32 and at least one second strap 35, wherein the first transparent plastic body 31 is formed onto the core wire 30 by an extrusion molding method, and completely wrapped around the core wire 30, and maintains a predetermined cross-sectional area, and the first strap 33 is wound spirally onto the first transparent plastic body 31 and along an axial direction of the first transparent plastic body 31 and keeps a predetermined interval along the first transparent plastic body 31, and each second strap 35 is wound spirally onto the first transparent plastic body 31 in an opposite direction with the first strap 33 and along the axial direction of the first transparent plastic body 31, and keeps a predetermined interval along the first transparent plastic body 31, so that each strap 33, 35 shows a hollow spiral form due to the property of a transparent material of the first transparent plastic body 31, and the second transparent plastic body 32 is formed onto the first transparent plastic body 31 by the extrusion molding method, and completely wrapped around the first transparent plastic body 31 and each strap 33, 35, and the second transparent plastic body 32 has a thickness falling within a range from 0.5 mm to 1.5 mm.

Since the decorating wire 3 includes the spiral straps 33, 35, therefore each strap 33, 35 can show a visual effect of being wound onto the second transparent plastic body 32 by the light refraction effect due to the thickness of the second transparent plastic body 32. The decorating wire 3 is woven as a finished good or sewed to a seam of an object 4 to enhance the overall beauty and the design variability of the finished good and the object 4 effectively.

In this preferred embodiment, each second strap 35 is wound onto the first transparent plastic body 31 and along the first transparent plastic body 31 in a direction not limited a spiral direction opposite to the first strap 33 and keeping a predetermined interval, but each second strap 35 can be wound in a different way according to the actual design of the decorating wire 3. For example, the second strap 35 can be wound in the same direction of the first strap 33 with a different interval, as long as the decorating wire 3 is woven as a finished good or sewed to a seam of an object 4 to effectively enhance the overall beauty and the design variability of the finished good and the object 4.

In the foregoing two preferred embodiments, at least one connecting plate 320 is extended outwardly from a surface of the second transparent plastic body 32 as shown in FIG. 3, and each connecting plate 320 is extended along an axial direction of the decorating wire 3, such that the decorating wire 3 can be sewed to a seam of the object 4 through each connecting plate 320 and matched with the original color of the leather or fabric material of the object 4 to enhance the overall beauty of the object 4 effectively.

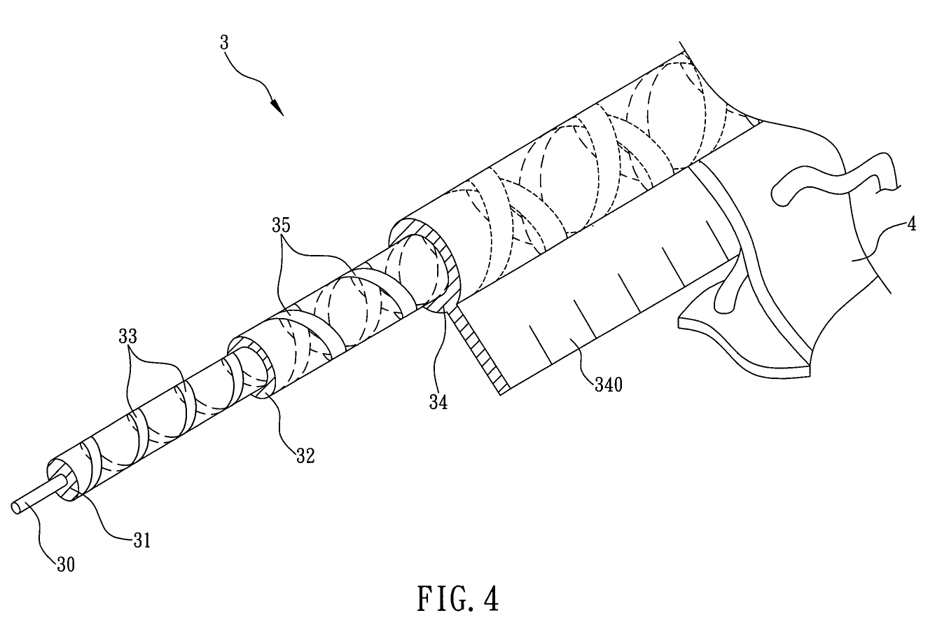

With reference to FIG. 4 for a decorating wire in accordance with a third preferred embodiment of the present invention, the decorating wire 3 comprises a core wire 30, a first transparent plastic body 31, a first strap 33, a second transparent plastic body 32, at least one second strap 35 and a third transparent plastic body 34, wherein the first transparent plastic body 31 is formed onto the core wire 30 by an extrusion molding method, and completely wrapped around the core wire 30, and maintains a predetermined cross-sectional area, and the first strap 33 is wound spirally onto the first transparent plastic body 31 and along an axial direction of the first transparent plastic body 31, and keeps a predetermined interval, such that the first strap 33 can show a hollow spiral form due to the property of a transparent material of the first transparent plastic body 31, and the second transparent plastic body 32 is formed onto the first transparent plastic body 31 by the extrusion molding method, and completely wrapped around the first transparent plastic body 31 and the first strap 33, and each second strap 35 is wound spirally onto the second transparent plastic body 32 and along an axial direction of the second transparent plastic body 32, and in a direction opposite to the first strap 33, and keeps a predetermined interval, and the third transparent plastic body 34 is formed onto the second transparent plastic body 32 by the extrusion molding method, and completely wrapped around the second transparent plastic body 32 and each second strap 35, and the second transparent plastic body 32 and the third transparent plastic body 34 have thicknesses falling within a range from 0.5 mm to 1.5 mm.

Each strap 33, 35 can show a visual effect of being wound onto the third transparent plastic body 34 by the light refraction effect due to the thickness of the second transparent plastic body 32 and the third transparent plastic body 34. Since the decorating wire 3 has several spiral straps 33, 35, therefore the first strap 33 and each second strap 35 can show the visual effect of being wound onto the second transparent plastic body 32 and the third transparent plastic body 34 by the light refraction effect due to the thicknesses of the second transparent plastic body 32 and the third transparent plastic body, so that the decorating wire 3 can be woven as a finished good or sewed to a seam of an object 4 to enhance the overall beauty and the design variability of the finished good and the object 4 effectively.

In this preferred embodiment, each second strap 35 is wound onto the second transparent plastic body 32 and along an axial direction of the second transparent plastic body 32, but not limited to a spiral direction opposite to the first strap 33 and maintaining a predetermined interval along the second transparent plastic body 32. Each second strap 35 can also be wound by another method according to the actual design of the decorating wire. For example, the second strap 35 is wound spirally in the same direction of the first strap 33 and maintains a different interval along the second transparent plastic body 32. As long as the decorating wire 3 can be woven as a finished good or sewed to a seam of the object 4, the overall beauty and the design variability of the finished good and the object 4 can be enhanced effectively.

In FIG. 4, at least one connecting plate 340 is extended outwardly from a surface of the third transparent plastic body 34, and each connecting plate 340 is extended along an axial direction of the decorating wire 3, such that the decorating wire 3 can be sewed to a seam of the object 4 through each connecting plate 340 and matched with the original color of the leather or fabric material of the object 4 to enhance the overall beauty of the object 4 effectively.

In the preferred embodiment as shown in FIG. 4, the axial strength of the core wire 30 is greater than each of the first transparent plastic body 31, the second transparent plastic body 32 and the third transparent plastic body 34, such that the core wire 30 can enhance the axial strength of the first transparent plastic body 31, the second transparent plastic body 32 and the third transparent plastic body 34 for preventing the first transparent plastic body 31, the second transparent plastic body 32 and the third transparent plastic body 34 from being deformed, cracked or broken during the extrusion molding process and enhance the manufacturing yield of the decorating wire 3 effectively.

In summation of the description above, the decorating wire 3 of the invention as shown in FIGS. 2 and 3 can enhance the overall beauty and the design variability of a manufactured object (such as a cushion, a stationery bag, a cosmetic bag or any other bag). Since the surface of the decorating wire 3 is protected by the second transparent plastic body 32 or the third transparent plastic body 34, therefore the life expectancy of the decorating wire 3 can be extended effectively.

While the invention has been described by means of specific embodiments, numerous modifications and variations could be made thereto by those skilled in the art without departing from the scope and spirit of the invention set forth in the claims.

What is claimed is:

1. A decorating wire capable of showing a hollow spiral strap, comprising:
a core wire;
a first transparent plastic body, formed onto the core wire by an extrusion molding method, and completely wrapped around the core wire, and maintaining a predetermined cross-sectional area;
a first strap, wound onto the first transparent plastic body spirally along an axial direction of the first transparent plastic body; and
a second transparent plastic body, formed onto the first transparent plastic body by the extrusion molding method, and completely wrapped around the first transparent plastic body and the first strap, and maintaining a predetermined cross-sectional area, and the second transparent plastic body having a thickness falling within a range from 0.5 mm to 1.5 mm.

2. The decorating wire capable of showing a hollow spiral strap as recited in claim 1, wherein the core wire has an axial strength greater than the first transparent plastic body and the second transparent plastic body.

3. The decorating wire capable of showing a hollow spiral strap as recited in claim 2, wherein the second transparent plastic body includes at least one connecting plate extended outwardly from a surface of the second transparent plastic body, and each connecting plate is extended along an axial direction of the decorating wire.

4. The decorating wire capable of showing a hollow spiral strap as recited in claim 3, wherein the first strap is wound onto the first transparent plastic body while maintaining a predetermined interval along the first transparent plastic body.

5. A decorating wire capable of showing a hollow spiral strap, comprising:
a core wire;
a first transparent plastic body, formed onto the core wire by an extrusion molding method, and completely wrapped around the core wire, and maintaining a predetermined cross-sectional area;
a first strap, wound onto the first transparent plastic body spirally along an axial direction of the first transparent plastic body;
a second transparent plastic body, formed onto the first transparent plastic body by the extrusion molding method, and completely wrapped around the first transparent plastic body and the first strap, and maintaining a predetermined cross-sectional area, and the second transparent plastic body having a thickness falling within a range from 0.5 mm to 1.5 mm;
at least one second strap, wound onto the second transparent plastic body in a same direction or an opposite direction with the first strap and along an axial direction of the second transparent plastic body; and
a third transparent plastic body, formed onto the second transparent plastic body by the extrusion molding method, and completely wrapped around the second transparent plastic body and each second strap, and maintaining a predetermined cross-sectional area, and the third transparent plastic body having a thickness falling within a range from 0.5 mm to 1.5 mm.

6. The decorating wire capable of showing a hollow spiral strap as recited in claim 5, wherein the core wire has an axial strength greater than the first transparent plastic body, the second transparent plastic body and the third transparent plastic body.

7. The decorating wire capable of showing a hollow spiral strap as recited in claim 6, wherein the third transparent plastic body includes at least one connecting plate extended outwardly from a surface of the third transparent plastic body, and each connecting plate is extended along an axial direction of the decorating wire.

8. The decorating wire capable of showing a hollow spiral strap as recited in claim 7, wherein the first strap is wound onto the first transparent plastic body while maintaining a predetermined interval along the first transparent plastic body, and each second strap is wound onto the second transparent plastic body while maintaining a predetermined interval along the second transparent plastic body.

9. A decorating wire capable of showing a hollow spiral strap, comprising:
a core wire;
a first transparent plastic body, formed onto the core wire by an extrusion molding method, and completely wrapped around the core wire, and maintaining a predetermined cross-sectional area;
a first strap, wound onto the first transparent plastic body spirally along an axial direction of the first transparent plastic body;
at least one second strap, wound onto the first transparent plastic body and the first strap in a same direction or an opposite direction with the first strap and along an axial direction of the first transparent plastic body; and
a second transparent plastic body, formed onto the first transparent plastic body by the extrusion molding method, and completely wrapped around the first transparent plastic body and each strap, and maintaining a predetermined cross-sectional area, and the second transparent plastic body having a thickness falling within a range from 0.5 mm to 1.5 mm.

10. The decorating wire capable of showing a hollow spiral strap as recited in claim 9, wherein the core wire has an axial strength greater than the first transparent plastic body and the second transparent plastic body.

11. The decorating wire capable of showing a hollow spiral strap as recited in claim 9, wherein the second transparent plastic body includes at least one connecting plate extended outwardly from a surface of the second transparent plastic body, and each connecting plate is extended along an axial direction of the decorating wire.

12. The decorating wire capable of showing a hollow spiral strap as recited in claim 11, wherein each strap is wound onto the first transparent plastic body, while maintaining a predetermined interval along the first transparent plastic body.
